(19) United States
(12) Patent Application Publication
(10) Pub. No.: US 2006/0112414 A1
(43) Pub. Date: May 25, 2006

(54) A DATA TRANSFER ADAPTOR AND A METHOD FOR TRANSFERRING DATA

(75) Inventors: Ari Ikonen, 21280 Raisio (FI); Pekka Heinonen, 02100 Espoo (FI); Harri Okkonen, Mountain View, CA (US)

Correspondence Address: PERMAN & GREEN, 425 POST ROAD, FAIRFIELD, CT, 06824, US

(73) Assignee: Nokia Corporation, 02150 Espoo (FI)

(21) Appl. No.: 09/587,959

(22) Filed: Jun. 6, 2000

(30) Foreign Application Priority Data
Jun. 7, 1999 (FI) 991299

(51) Int. Cl. H04N 7/173

(52) U.S. Cl. 725/133

(57) ABSTRACT

Abstract of the Disclosure

A coupling device to connect an external device, e.g. a mobile station, to a television receiver through a SCART or antenna connection using an LPRF link (e.g. Bluetooth). The coupling device contains the necessary electronics to receive the signal sent from the mobile station as an LPRF radio signal and convert it to a format suitable for television. The coupling device can be built as a small adapter that attaches directly to the SCART connector of the TV. The coupling device can be arranged to be capable of e.g. relaying a signal from a video recorder to the TV and to replace the signal with a signal presenting the information sent by the mobile station.

### Detailed Description of the Invention

### FIELD OF THE INVENTION

The present invention relates to connecting an external audio-visual device to a second device, especially connecting a TV-device to another device.

### BACKGROUND OF THE INVENTION

When designing a mobile station, one should on one hand minimise the size of the device so that it would be as portable as possible, and on the other hand build a display as large as possible in order to be able to present information on the mobile station as well as possible. There have been plans to use future mobile stations like computers to browse the Internet and even to transmit moving picture. The mobile station's own display unit, small because of demands of portability, is not always the best possible. It is also possible to receive high-quality audio signal, even music, with advanced mobile stations. The small speaker of a mobile station can be somewhat restricted for this purpose, especially if there are several listeners. The ability of a mobile station to store received AV-information is also very restricted. Nonetheless, In some situations it would be preferable to be able to store information received via a mobile station without being restricted to the data storage capacity of the mobile station.

The patent application publication EP 804012 A2 presents a method, where a mobile station can be used for transferring the identification data of a subscriber of pay-per-view information for their television to the sender of the information. In order to deliver pay-per-view information it is essential to be able to reliably identify the subscriber of the information and a feedback provided by a mobile station offers a cheap means. The mobile station's own PIN-code can be used to identify the subscriber. However, in order to be able to use the method, a connection must be constructed between the mobile station and the television. Such a connection may require special adaptation of the television devices for them to function with a mobile station. Such an adaptation would cause additional cost and compatibility problems between devices manufactured by different manufacturers. Additionally, a connection to a television by a cable requires a cable to be connected both to the mobile station and the television prior to using the method. In this case the user must leave the mobile station connected to the television at least for a while and the mobile station may easily be forgotten in place when the user leaves the television set. In worst case such a situation may offer a chance of abuse for a third party, if the connection is forgotten open.

### SUMMARY OF THE INVENTION

Now an adapter has been invented, by means of which an external device, e.g. a mobile station can be connected to a television device in such a way that the television device can be used as a display of the external device. The invention is preferably realised with a short-range radio connection adapter, such as a LPRF (Low-Power Radio Frequency) adapter, which has been arranged to be able to communicate with an external device via an LPRF-link, and which adapter has been adapted to be connected to a SCART (Syndicat des Constructeurs d'Appareils Radio Récepteurs et Téléviseurs) or antenna connector of the television device. Even more preferably the adapter also comprises a SCART input connector to couple the adapter e.g. between the TV and a VCR in order to allow normal use of the VCR. Alternatively, the adapter can be built according to a second embodiment of the present invention to use instead of or along with SCART connector the antenna connector of the television device, in which case the adapter is coupled between the television device and its antenna cable. Said external device can be e.g. a mobile station, an electronic game, a PDA-device, a portable computer or a video camera.

A TV-device in this context denotes a device capable of receiving a TV-signal, such as a television receiver, a TV-projector (a device to project TV-image on a screen) and a video recorder.

An advantage of the present invention is that an external device, e.g. a mobile station, can be coupled to a television device using the open LPRF-standard, in which case the coupling can be done easily independently of the make and model of the external device and the television device by using an easily portable adapter, which can quickly be installed by an ordinary consumer. Due to the characteristics of radio waves, the coupling is also insusceptible to minor obstacles and will function even if there is no line of sight between the external device and the adapter, e.g. when the adapter is behind the television device. Preferably the adapter has been arranged to use a SCART-connector and the fast blanking -function characteristic thereto, which function enables the adapter, when receiving information from an external device, to automatically force the television device to present the information supplied by the adapter. The adapter can also be used to receive information from the television device to an external device. E.g. commercials or other information can be received from text television to the external device. The text television information is already in digital form. As an advantage of the LPRF-link such an information transfer connection can easily be arranged for e.g. a mobile station, because when the user is near the television device, his/her personal mobile station is also near the television device. An LPRF-link allows communication between an external device and a television device even if they have not been connected with wires and they do not have a direct line of sight or a proper reflection e.g. off a wall. The user can also e.g. keep his/her mobile station on belt attached to a belt clip, in which case the mobile station is in no danger of being left behind when the user leaves the place later.

Preferably the adapter has also been arranged to comprise a connector to external program source, such as a VCR and/or a video camera, in order to make the adapter transparent to the television device attached to it and to allow the television device use an external program source normally. In an embodiment of the present invention the adapter has been arranged to also comprise an infrared port to allow e.g. a portable computer or a video camera conforming to the IrDA (Infrared Data Association)-standard to be connected to a television device.

In a second embodiment of the present invention the adapter comprises means for adding or mixing information to a TV-image being presented simultaneously, e.g. similarily to text television's mix function.

In a third embodiment of the present invention the adapter has been integrated to a charging device of an external device (e.g. a mobile station), in which case the user only has to carry with him/her the external device and the charging device in order to be able to use a TV-device as an AV-terminal of the external device.

A coupling device according to the invention for attaching an external device to a television device, which television device has a first input to receive an external information signal in certain first format, is characterised in that the coupling device comprises

short range radio frequency communication means for receiving information from an external device;

means for converting the received information into said information signal in first format; and

a first output for supplying said information signal in the first format to the first input of said television device.

A system according to the invention comprising an external device and a television device,

which external device has means for short rance radio frequency communication for sending information; and

which television device has a first input to receive a certain external information signal in a first format, is characterised in that

the system comprises a coupling device for receiving information from the external device to the television device to be presented on the television device, which coupling device comprises:

short range radio frequency communication means for receiving information from the external device;

means for converting received information to an information signal in said first format; and

a first output to supply said information signal in the first format to the first input of said television device.

A method according to the present invention for coupling an external device to a television device, which television device has a first input to receive external information signal, is characterised in that

a coupling device is attached to the first input in order to receive information;

information sent on a short range radio frequency connection is received on the coupling device;

received information is converted to a first format suitable for the television device; and

information in the first format is supplied to the first input of the television device.

### BRIEF DESCRIPTION OF THE DRAWINGS

The invention is explained in the following in detail by referring to the enclosed drawings and by using a mobile station as an example of an external device, where

figure 1 is a diagram of a system according to the invention;

figure 2 is a diagram of data transfer in a system according to the invention;

figure 3 is a block diagram of the structure of an LPRF-link module according to the invention to be connected to a SCART-connector;

figure 4 is a block diagram of the structure of an LPRF-link module according to the invention to be connected to an antenna connector;

figure 5 is a block diagram of the structure of a combined LPRF-link module and mobile station charging device according to a third implementation of the invention.

### DETAILED DESCRIPTION

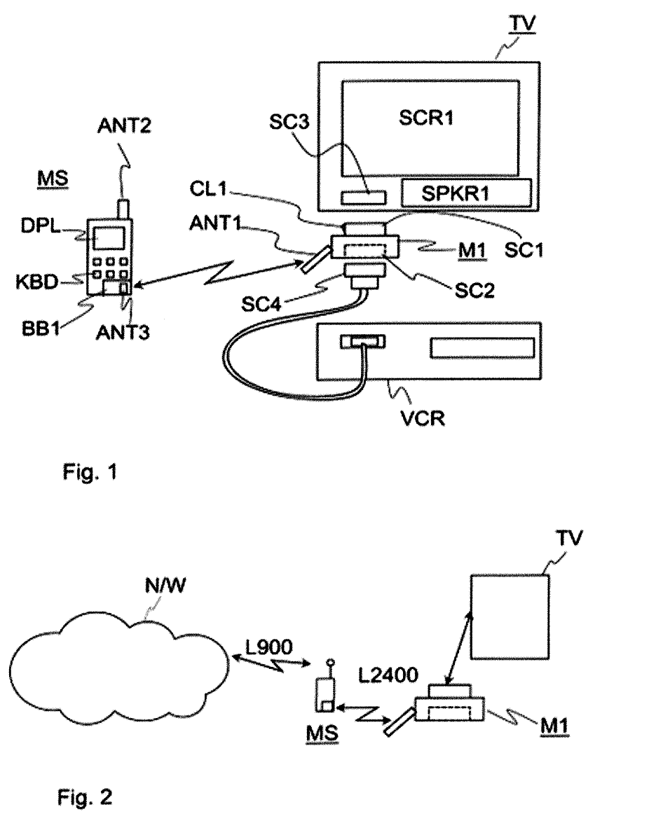

Figure 1 presents a system according to the invention comprising a mobile station MS, a television receiver TV, a video cassette recorder VCR and an adapter or link module M1. The TV and the VCR of the system are ordinary devices known from prior art. Here a link module M1, which can be used for coupling a mobile station to a television device through an LPRF-link, has been coupled between a TV and a VCR coupled together by means of a SCART connection. The link module comprises a first SCART output SC1 and a first SCART input SC2. The TV comprises a second SCART input SC3 and the VCR comprises a second SCART output SC4. Preferably, but not necessarily, the link module also comprises a flexible extension CL1 to attach detachably to said second SCART input SC3. Alternatively a friction joint can be used to attach the link module by manufacturing the first SCART output to fit snugly to the second SCART input. The link module is coupled to the television receiver though the second SCART input using the first SCART output. The purpose of the first SCART input is to enable the use of an exterlan AV device, such as a video cassette recorder VCR with the TV by sharind SC3 with the VCR. Thus the user does not have to detach the link module and connect the second SCART output of the VCR in the place of the link module in order to be able to view e.g. video image. The link module comprises an antenna ANT1 which enables it to communicate with the mobile station MS. The antenna has been drawn to protrude from the module, but preferably it is integrated inside the module M1. The mobile station is a mobile station, preferably a digital mobile station, such as a GSM-phone, with LPRF connecting means. The mobile station comprises a display DPL, a keyboard KBD and an antenna ANT2 along with an LPRF-part BB, which comprises an LPRF-antenna ANT3, which the mobile station uses to send information, e.g. text and/or graphics to be presented on the TV's screen, to the link module over an LPRF-link. Preferably the LPRF antenna ANT3 has been integrated inside the mobile station. Instead of a TV the mobile station can be connected e.g. to a TV-projector or a video cassette recorder by means of the link module. Especially in this way it is possible to store several hours of image and/or sound received on a mobile station.

Figure 2 is a diagram of data transfer in a system according to the invention. The system comprises a data transfer network N/W, with which the mobile station MS communicates e.g. through the base stations using the radio link L900, e.g. on the frequency band of about 900 MHz or 1800 MHz. The mobile station communicates with the link module on an LPRF link frequency, which may be e.g. 2400 MHz. The link module M1 in its turn has been coupled to the television through its SCART connector and it transfers information to the TV through the SCART connector.

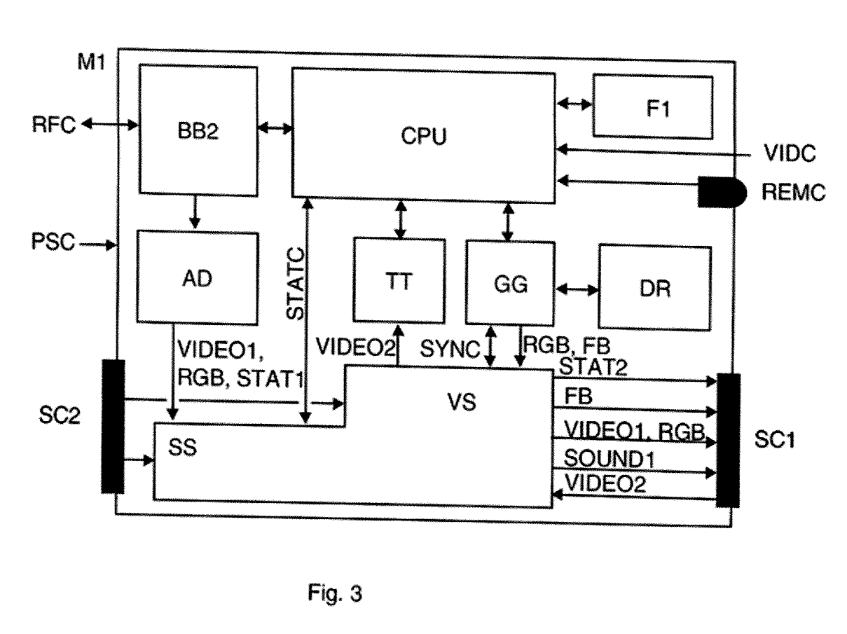

Figure 3 is a block diagram of a structure of a link module according to the invention to be attached to a SCART connector. The link module comprises a central processing unit CPU, which controls the operation of the link module. The link module comprises a first SCART connector SC1 to supply audio and video information to the television device and preferably, but not necessarily, a second SCART connector SC2 to receive external audio and video information. Naturally, the link module also comprises an LPRF radio block BB2, which in this example is a Bluetooth-standard compliant block for communication with an LPRF connection RFC. The block BB2 is controlled by CPU. The CPU operating instructions i.e. the program has preferably been stored in a Flash-memory F1, where the CPU can read them and which may optionally be used to store configuration data. Optionally the link module may also comprise in connection with the central processing unit an infrared port REMC to receive remote control or information relayed on IR. To adapt the text and/or graphics received by the link module to an RGB-signal the link module comprises a graphics generator GG, which, using the display memory DR, constructs the information relayed by the processor to RGB format. In order to bypass and re-establish the connection of the received SCART connector the link module comprises a sound switch SS, which is controlled by block AD (Audio Decoder), which functions as a decoder for the audio signal received over the LPRF-link. AD enables the audio data to be decoded as late as in the link module, but alternatively AD can be omitted, in which case MS must transfer the audio signal to the module in an already decoded form. When receiving sound, e.g. speech, from the mobile station over the LPRF link, which sound is desired to be played through the speakers of the television device, the sound switch, controlled by a signal STATC sent by the CPU, disconnects the external audio connector SC2 from SC1 and connects AD in place of SC2 to transmit an audio signal (e.g. speech, music or warning or game sounds produced by the mobile station) to the television device through SC1. Similarly the link module comprises a video switch VS which disconnects the video connection of SC2 from SC1 and connects GG to SC1, when GG issues a disconnecting command to VS. In this case GG gives an RGB-signal to SC1 through the video switch and an RGB synchro signal SYNC to video signal VIDEO1. The sound signal SS relays the sound signal SOUND1 to SC1. If SC2 receives a first status signal STAT1 signalling the entry of an external SCART signal from e.g. a video cassette recorder, VS preferably relays a second status signal STAT2 corresponding to the first status signal STAT1 to SC1, if the TV device is not required to present or store information provided by the mobile station. To replay the image sent by a mobile station connected to a TV device the switch preferably uses a fast blanking signal FB commonly used in SCART connections to force the TV device to display the image. A fast blank signal is an increase of voltage in the pin 8 (status control) of a SCART connector to over 2,5 volts. Preferably the video switch has been arranged to receive a video signal VIDEO2 (e.g. a composite signal) of a tuned channel from the reception circuits of the TV device and to relay syncro information from VIDEO2 to the graphics generator GG. Preferably the link module also comprises a text-TV block TT connected to VS and CPU. TT receives from VS a VIDEO2 signal and separates digital information from VIDEO2 for the CPU to be relayed over BB2 and RFC to MS.

The effect of the fast blank signal is indeed fast and it can be used to mix an RGB-signal into a TV picture e.g. to add a small message "You have a message" to the top edge of the picture. In this case VS gives a sync SYNC to the graphics generator GG and the GG is synchronised to the video of the incoming TV video signal, at which point a video synched RGB is added to the RGB-signal of the TV picture. If the TV video signal is received from e.g. a VCR on SC2, an RGB signal generated by GG and corresponding to the picture to be added to the TV picture is added to the RGB signal supplied by the VCR. Thus when the TV device has been tuned to a channel corresponding to the VCR, VIDEO2 will relay a sync of the video signal of the VCR, VIDEO1, to GG through VS, and GG synchronises an RGB signal generated by GG to be added to the RGB signal received from SC2. Then GG gives a synchronised RGB signal to VS, which combines the RGB generated by GG with the RGB received from SC2 and gives the combined RGB to SC1. The link module preferably also comprises a video camera input VIDC to couple a video camera to the link module. The link module can be arranged to be controlled (e.g. switched on or off) by an external remote control unit using infrared rays or alternatively its control can be realised with an LPRF connection using a mobile station. The link module comprises an internal power source (a battery) or a connector PSC to an external power source in order to receive the energy needed for its operation.

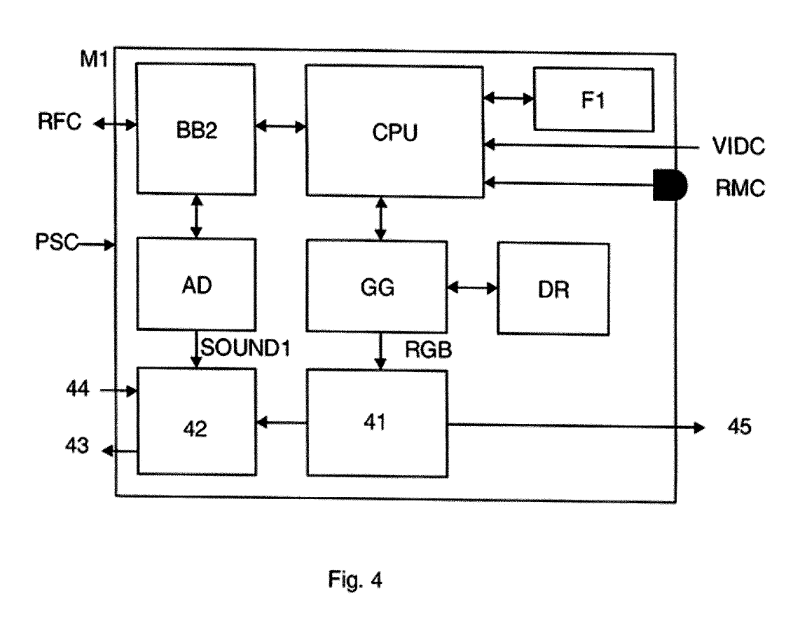

Figure 4 is a diagram of the structure on an LPRF link module according to the invention to be connected to an antenna connector, which diagram shows the parts relevant to explaining the present invention. The structure of the module is otherwise similar to that of the link module presented in figure 3, but here the pattern coming from the graphics generator is coded to a TV signal with a suitable coding (e.g. PAL, SECAM or NTSC) in block 41. The coded video signal is supplied to an RF modulator to block 42, where an eventual signal SOUND1 from the audio decoder AD is combined with it. Preferably the RF modulator relays as is the antenna signal received in the antenna connection to the television device, but reserves one channel to present information coming from a mobile station at least at those times, when it is receiving a coded video signal.

Both the link module in figure 3 and the one in figure 4 can be arranged to use e.g. a voltage connection of 3.3 V or 5 V. The power supply of the link module PSC can be arranged e.g. by a battery or mains device attached to the link module.

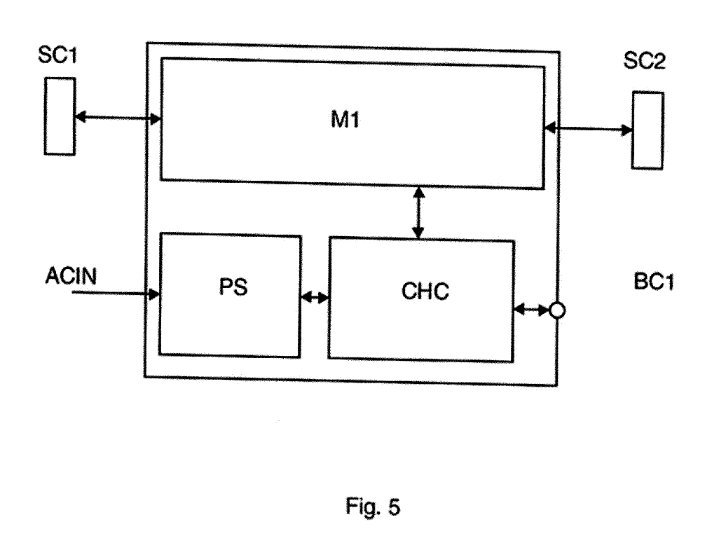

Figure 5 presents the structure of a combined LPRF link module and mobile station charging device according to the present invention. The device comprises a link module M1, e.g. the one presented in figure 3, a power supply PS (e.g. a transformer or a voltage converter) and a charging control block CHC. The SCART connectors SC1 and SC2 of M1 have preferably been arranged to the ends of flexible cables, so that the device may be placed e.g. on a TV. PS comprises an input ACIN for mains voltage and CHC comprises an output BC1 for a mobile station battery or a mobile station. When the device is coupled e.g. between a TV and a video cassette recorder, the device receives its operating voltage from the mains network converted by PS. CHC controls the charging of a mobile station battery attached to the device when needed. Preferably, though not necessarily, the device can be arranged to receive its operating voltage from a mobile station battery connected to the device through BC1, in which case the device can be operated also then, when there are no free mains sockets in the vicinity of the TV device. Also preferably, but not necessarily, the device comprises a power saving technology to turn off the unnecessary functions of the link module, until they are activated e.g. on the arrival of an excitation from the mobile station through the LPRF link. Thus the operating period of the device can be extended and an extended functioning period is made possible when the device is operated on a battery and not with mains voltage.

This has been a presentation of the implementation and embodiments of the present invention by aid of examples. It is obvious to a man skilled in the art that the present invention is not limited to the details of the embodiments presented above and that the present invention can be realised in another form without deviating from the characteristics of the present invention. The presented embodiments should be considered illuminatory and not restrictive. Thus the implementation and use possibilities of the present invention are indeed restricted only by the enclosed patent claims. E.g. the power saving technology described above can also be applied to the link modules in figures 3 and 4. Correspondingly, instead of LPRF, where the radio signal is 2,4 GHz and the range is about 10 m, a WLAN (Wireless Local Area Network) connection can be used, which connection is another short range radio connection with a range of as much as 100 m. Thus different implementation alternatives defined by the claims, also equivalent implementations belong to the area of the present invention.

What is Claimed is:

1. A coupling device for attaching an external device to a television device, which television device has a first input to receive a certain external information signal in certain first format, wherein the coupling device comprises
short range radio communicating means for receiving information from the external device;
means for converting received information to an information signal in a first format; and
a first output for supplying said information signal in the first format to the first input of said television device.

2. A coupling device according to claim 1, wherein
the coupling device comprises a second input for receiving an external picture signal to be relayed to the television device through said first output.

3. A coupling device according to claim 1, wherein
said first output is a SCART-connector.

4. A coupling device according to claim 1, wherein
said first output is an antenna cable connector.

5. A coupling device according to claim 2, wherein
said coupling device comprises switching means to disconnect a signal entering said second input from said first output when the coupling device is communicating with said external device and to connect the signal entering the second input to said first output when the coupling device is not communicating with said external device.

6. A coupling device according to claim 1, wherein
said external device is battery operated, and
said coupling device comprises means for charging a battery of said external device.

7. A coupling device according to claim 1, wherein the coupling device comprises
means for receiving a second information from a television program source; and
means to send said second information through a short range radio connection to said external device.

8. A coupling device according to claim 1, wherein
said information comprises at least one of the following: picture and sound information.

9. A coupling device according to claim 1, wherein
said external device is a mobile station.

10. A coupling device according to claim 1, wherein
said short range radio connection is an LPRF link.

11. A coupling device according to claim 1, wherein
by coupling said first output to said first input said external device is detachably attachable to a television device.

12. A coupling device according to claim 1, wherein said external device comprises means for attaching said external device detachably to a television device.

13. A system comprising an external device and a television device,
which external device has short range radio communicating means for receiving certain external information signal in a first format, wherein
the system comprises a coupling device for receiving information from an external device to a television device to be presented on the television device, which coupling device comprises:
short range radio communicating means for receiving information from an external device;
means for converting the received information to an information signal in said first format; and
a first output to supply said information signal in the first format to the first input of said television device.

14. A method for coupling an external device to a television device, which television device contains a first input to receive an external information signal, wherein
a coupling device is attached to the first input to receive information;
information sent on a short range radio connection is received from an external device;
received information is converted to a first format suitable to the television device; and
information in said first format is supplied to said first input.
